(19) United States
(12) Patent Application Publication
(10) Pub. No.: US 2005/0136317 A1
(43) Pub. Date: Jun. 23, 2005

(54) Molded multi-part flow field structure

(75) Inventor: Dennis E. Ferguson, Mahtomedi, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/740,985

(22) Filed: Dec. 19, 2003

(51) Int. Cl. H01M 8/02; H01M 2/08; H01M 8/24; B28B 5/00

(52) U.S. Cl. 429/38; 429/35; 264/251; 264/260

(57) ABSTRACT

A molded multi-part flow field structure includes a molded flow field plate formed of a conductive material comprising a first polymer. A molded frame is disposed around the flow field plate and formed of a non-conductive material comprising a second polymer. The molded flow field plate and frame preferably define a unipolar flow field structure. Manifolds are formed in the molded frame, and a molded gasket arrangement is disposed proximate a periphery of the manifolds. A molded coupling arrangement may be formed to extend from the frame and configured to couple the flow field structure with other unipolar flow field structures to define a continuous web of the unipolar flow field structures.

### FIELD OF THE INVENTION

The present invention relates generally to fuel cells and, more particularly, to molded flow field structures for use in discrete and roll-good fuel cell assemblies.

### BACKGROUND OF THE INVENTION

A typical fuel cell system includes a power section in which one or more fuel cells generate electrical power. A fuel cell is an energy conversion device that converts hydrogen and oxygen into water, producing electricity and heat in the process. Each fuel cell unit may include a proton exchange member at the center, electrodes adjacent each side of the proton exchange members and gas diffusion layers adjacent the catalyst layers. Anode and cathode unipolar or bipolar plates are respectively positioned at the outside of the gas diffusion layers.

The reaction in a single fuel cell typically produces less than one volt. A plurality of the fuel cells may be stacked and electrically connected in series to achieve a desired voltage. Electrical current is collected from the fuel cell stack and used to drive a load. Fuel cells may be used to supply power for a variety of applications, ranging from automobiles to laptop computers.

The efficacy of fuel cells as a well established energy generating technology may largely depend on new manufacturing techniques that provide for higher throughputs at reduced material and fabrication costs.

### SUMMARY OF THE INVENTION

The present invention is directed to a flow field structure for use in a fuel cell assembly. More particularly, the present invention is directed to a molded multi-part flow field structure preferably having a unipolar or monopolar configuration, it being understood that bipolar configurations are also contemplated. A flow field structure, according to one embodiment, includes a molded flow field plate formed of a conductive material comprising a first polymer. A molded frame is disposed around the flow field plate and formed of a non-conductive material comprising a second polymer. Manifolds are formed in the molded frame, and a molded gasket arrangement is disposed proximate a periphery of the manifolds.

According to another embodiment, a flow field structure for use in a fuel cell assembly includes a molded flow field plate formed of a conductive material comprising a first polymer and a molded frame disposed around the flow field plate and formed of a non-conductive material comprising a second polymer. A molded coupling arrangement extends from the frame. The molded coupling arrangement is configured to couple the unipolar flow field structure with other unipolar flow field structures to define a continuous web of the unipolar flow field structures.

In accordance with a further embodiment, a method of forming a flow field structure for use in a fuel cell assembly involves molding a flow field plate and manifolds in the flow field plate using a conductive material comprising a first polymer. A frame is molded around the flow field plate using a non-conductive material comprising a second polymer. A gasket arrangement is molded proximate a periphery of the manifolds.

According to another embodiment, a method of forming a flow field structure for use in a fuel cell assembly involves molding a flow field plate using a conductive material comprising a first polymer, and molding a frame around the flow field plate using a non-conductive material comprising a second polymer. The method further involves molding a coupling arrangement between the flow field structure and other ones of the flow field structure to define a continuous web of the flow field structures.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1A is an illustration of a fuel cell and its constituent layers;

FIG. 1B illustrates a unitized cell assembly having a unipolar configuration in accordance with an embodiment of the present invention;

FIG. 1C illustrates a unitized cell assembly having a unipolar/bipolar configuration in accordance with an embodiment of the present invention;

FIG. 2 illustrates two sides of a molded unipolar flow field structure in accordance with an embodiment of the present invention, the two sides being a flow field side and a cooling side;

FIG. 3 illustrates various features of the flow field side of a molded flow field structure in accordance with an embodiment of the present invention;

FIG. 4 is an exploded view of various features of the flow field structure shown in FIG. 3 taken from section A-A;

FIGS. 5 and 6 illustrate two joint configurations that provide for interlocking engagement between a flow field plate and a frame in accordance with an embodiment of the present invention;

FIGS. 7 and 8 illustrate an embodiment of a sealing gasket molded on a frame of a flow field structure in accordance with an embodiment of the present invention;

FIGS. 9A and 9B illustrate embodiments of a microstructured sealing gasket molded on a frame of a flow field structure in accordance with an embodiment of the present invention;

FIG. 10A illustrates an embodiment of a molded coupling arrangement provided between adjacent flow field structures in accordance with an embodiment of the present invention;

FIG. 10B illustrates features of the molded coupling arrangement shown in FIG. 10A in accordance with an embodiment of the present invention;

FIG. 11 illustrates another embodiment of a molded coupling arrangement provided between adjacent flow field structures in accordance with an embodiment of the present invention;

FIG. 12 illustrates a further embodiment of a molded coupling arrangement provided between adjacent flow field structures in accordance with an embodiment of the present invention;

FIG. 13 illustrates yet another embodiment of a molded coupling arrangement provided between adjacent flow field structures in accordance with an embodiment of the present invention;

FIGS. 14A and 14B illustrate a further embodiment of a molded coupling arrangement provided between adjacent flow field structures in accordance with an embodiment of the present invention;

FIGS. 15 and 16A-16B illustrate a molding apparatus for molding flow field structures in accordance with an embodiment of the present invention;

FIG. 17 illustrates a molding apparatus for molding flow field structures and for encapsulating unitized fuel cell assemblies in accordance with an embodiment of the present invention; and

FIGS. 18-21 illustrate fuel cell systems within which one or more fuel cell stacks employing molded multi-part flow field structures of the present invention may be employed.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

A molded multi-part flow field structure of the present invention may be incorporated in fuel cell assemblies of varying types, configurations, and technologies. A molded multi-part flow field structure preferably has a unipolar or monopolar configuration. A unipolar flow field structure of the present invention may be employed with one or more other unipolar flow field structure to construct fuel cell assemblies of various configurations. Unipolar flow field structure of the present invention may also be employed with one or more bipolar flow field structure to construct fuel cell assemblies of various configurations. Although a molded multi-part flow field structure of the present invention is generally described herein within the context of unipolar configurations, it is understood that bipolar flow field structure may also be constructed in accordance with the principles of the present invention. Accordingly, various embodiments of fuel cell assemblies that incorporate unipolar, bipolar, and both unipolar and bipolar flow field structures are described below for purposes of illustration, and not of limitation.

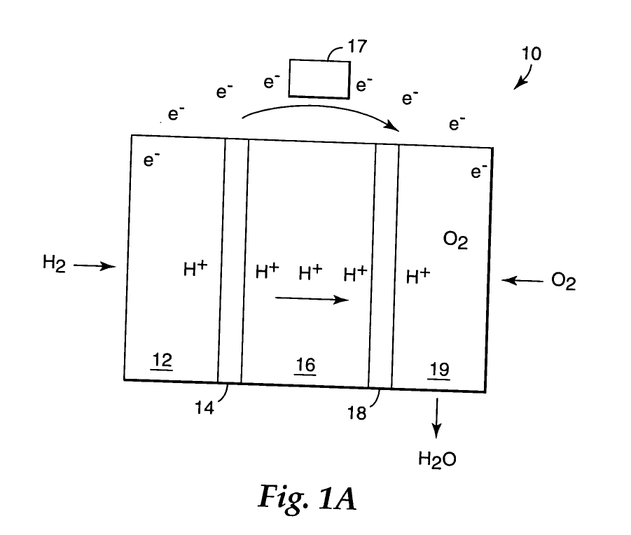

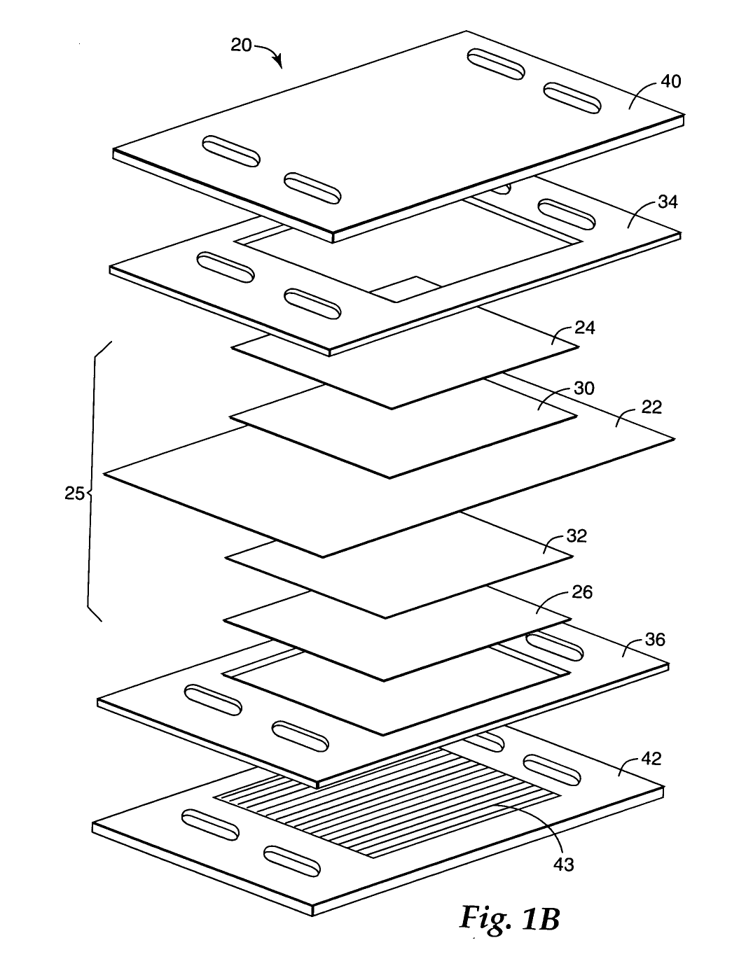

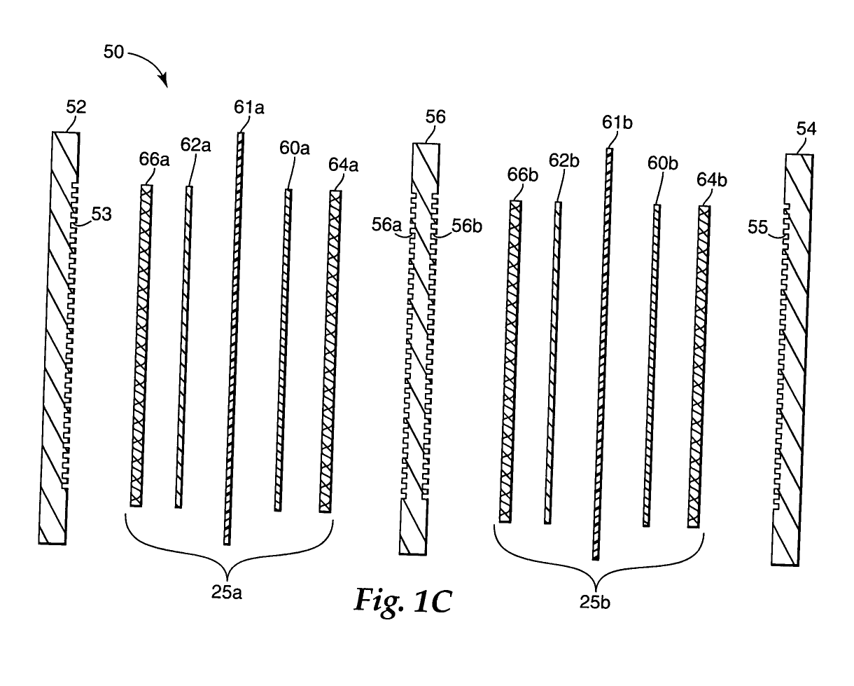

A typical fuel cell is depicted in FIG. 1A. A fuel cell is an electrochemical device that combines hydrogen fuel and oxygen from the air to produce electricity, heat, and water. Fuel cells do not utilize combustion, and as such, fuel cells produce little if any hazardous effluents. Fuel cells convert hydrogen fuel and oxygen directly into electricity, and can be operated at much higher efficiencies than internal combustion electric generators, for example.

The fuel cell 10 shown in FIG. 1A includes a first fluid transport layer (FTL) 12 adjacent an anode 14. The FTL may also be called a gas diffusion layer (GDL) or a diffuser/current collector (DCC). Adjacent the anode 14 is an electrolyte membrane 16. A cathode 18 is situated adjacent the electrolyte membrane 16, and a second fluid transport layer 19 is situated adjacent the cathode 18. In operation, hydrogen fuel is introduced into the anode portion of the fuel cell 10, passing through the first fluid transport layer 12 and over the anode 14. At the anode 14, the hydrogen fuel is separated into hydrogen ions (H⁺) and electrons (e⁻).

The electrolyte membrane 16 permits only the hydrogen ions or protons to pass through the electrolyte membrane 16 to the cathode portion of the fuel cell 10. The electrons cannot pass through the electrolyte membrane 16 and, instead, flow through an external electrical circuit in the form of electric current. This current can power an electric load 17, such as an electric motor, or be directed to an energy storage device, such as a rechargeable battery.

Oxygen flows into the cathode side of the fuel cell 10 via the second fluid transport layer 19. As the oxygen passes over the cathode 18, oxygen, protons, and electrons combine to produce water and heat.

Individual fuel cells, such as that shown in FIG. 1A, can be packaged as unitized fuel cell assemblies. Unitized fuel cell assemblies, referred to herein as unitized cell assemblies (UCAs), can be combined with a number of other UCAs to form a fuel cell stack. The UCAs may be electrically connected in series with the number of UCAs within the stack determining the total voltage of the stack, and the active surface area of each of the cells determines the total current. The total electrical power generated by a given fuel cell stack can be determined by multiplying the total stack voltage by total current.

A number of different fuel cell technologies can be employed to construct UCAs in accordance with the principles of the present invention. For example, a UCA packaging methodology of the present invention can be employed to construct proton exchange membrane (PEM) fuel cell assemblies. PEM fuel cells operate at relatively low temperatures (about 175° F./80° C.), have high power density, can vary their output quickly to meet shifts in power demand, and are well suited for applications where quick startup is required, such as in automobiles for example.

The proton exchange membrane used in a PEM fuel cell is typically a thin plastic sheet that allows hydrogen ions to pass through it. The membrane is typically coated on both sides with highly dispersed metal or metal alloy particles (e.g., platinum or platinum/ruthenium) that are active catalysts. The electrolyte used is typically a solid perfluorinated sulfonic acid polymer. Use of a solid electrolyte is advantageous because it reduces corrosion and management problems.

Hydrogen is fed to the anode side of the fuel cell where the catalyst promotes the hydrogen atoms to release electrons and become hydrogen ions (protons). The electrons travel in the form of an electric current that can be utilized before it returns to the cathode side of the fuel cell where oxygen has been introduced. At the same time, the protons diffuse through the membrane to the cathode, where the hydrogen ions are recombined and reacted with oxygen to produce water.

A membrane electrode assembly (MEA) is the central element of PEM fuel cells, such as hydrogen fuel cells. As discussed above, typical MEAs comprise a polymer electrolyte membrane (PEM) (also known as an ion conductive membrane (ICM)), which functions as a solid electrolyte.

One face of the PEM is in contact with an anode electrode layer and the opposite face is in contact with a cathode electrode layer. Each electrode layer includes electrochemical catalysts, typically including platinum metal. Fluid transport layers (FTLs) facilitate gas transport to and from the anode and cathode electrode materials and conduct electrical current.

In a typical PEM fuel cell, protons are formed at the anode via hydrogen oxidation and transported to the cathode to react with oxygen, allowing electrical current to flow in an external circuit connecting the electrodes. The anode and cathode electrode layers may be applied to the PEM or to the FTL during manufacture, so long as they are disposed between PEM and FTL in the completed MEA.

Any suitable PEM may be used in the practice of the present invention. The PEM typically has a thickness of less than 50 μm, more typically less than 40 μm, more typically less than 30 μm, and most typically about 25 μm. The PEM is typically comprised of a polymer electrolyte that is an acid-functional fluoropolymer, such as Nafion® (DuPont Chemicals, Wilmington Del.) and Flemion® (Asahi Glass Co. Ltd., Tokyo, Japan). The polymer electrolytes useful in the present invention are typically copolymers of tetrafluoroethylene and one or more fluorinated, acid-functional comonomers.

Typically, the polymer electrolyte bears sulfonate functional groups. Most typically, the polymer electrolyte is Nafion®. The polymer electrolyte typically has an acid equivalent weight of 1200 or less, more typically 1100, and most typically about 1000.

Any suitable FTL may be used in the practice of the present invention. Typically, the FTL is comprised of sheet material comprising carbon fibers. The FTL is typically a carbon fiber construction selected from woven and non-woven carbon fiber constructions. Carbon fiber constructions which may be useful in the practice of the present invention may include: Toray Carbon Paper, SpectraCarb Carbon Paper, AFN non-woven carbon cloth, Zoltek Carbon Cloth, and the like. The FTL may be coated or impregnated with various materials, including carbon particle coatings, hydrophilizing treatments, and hydrophobizing treatments such as coating with polytetrafluoroethylene (PTFE).

Any suitable catalyst may be used in the practice of the present invention. Typically, carbon-supported catalyst particles are used. Typical carbon-supported catalyst particles are 50-90% carbon and 10-50% catalyst metal by weight, the catalyst metal typically comprising Pt for the cathode and Pt and Ru in a weight ratio of 2:1 for the anode. The catalyst is typically applied to the PEM or to the FTL in the form of a catalyst ink. The catalyst ink typically comprises polymer electrolyte material, which may or may not be the same polymer electrolyte material which comprises the PEM.

The catalyst ink typically comprises a dispersion of catalyst particles in a dispersion of the polymer electrolyte. The ink typically contains 5-30% solids (i.e. polymer and catalyst) and more typically 10-20% solids. The electrolyte dispersion is typically an aqueous dispersion, which may additionally contain alcohols, polyalcohols, such a glycerin and ethylene glycol, or other solvents such as N-methylpyrrolidone (NMP) and dimethylformamide (DMF). The water, alcohol, and polyalcohol content may be adjusted to alter rheological properties of the ink. The ink typically contains 0-50% alcohol and 0-20% polyalcohol. In addition, the ink may contain 0-2% of a suitable dispersant. The ink is typically made by stirring with heat followed by dilution to a coatable consistency.

The catalyst may be applied to the PEM or the FTL by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

Direct methanol fuel cells (DMFC) are similar to PEM cells in that they both use a polymer membrane as the electrolyte. In a DMFC, however, the anode catalyst itself draws the hydrogen from liquid methanol fuel, eliminating the need for a fuel reformer. DMFCs typically operate at a temperature between 120-190° F./49-88° C. A direct methanol fuel cell can be subject to UCA packaging in accordance with the principles of the present invention.

Referring now to FIG. 1B, there is illustrated an embodiment of a UCA implemented in accordance with a PEM fuel cell technology. As is shown in FIG. 1B, a membrane electrode assembly (MEA) 25 of the UCA 20 includes five component layers. A PEM layer 22 is sandwiched between a pair of fluid transport layers 24 and 26. An anode 30 is situated between a first FTL 24 and the membrane 22, and a cathode 32 is situated between the membrane 22 and a second FTL 26.

In one configuration, a PEM layer 22 is fabricated to include an anode catalyst coating 30 on one surface and a cathode catalyst coating 32 on the other surface. This structure is often referred to as a catalyst-coated membrane or CCM. According to another configuration, the first and second FTLs 24, 26 are fabricated to include an anode and cathode catalyst coating 30, 32, respectively. In yet another configuration, an anode catalyst coating 30 can be disposed partially on the first FTL 24 and partially on one surface of the PEM 22, and a cathode catalyst coating 32 can be disposed partially on the second FTL 26 and partially on the other surface of the PEM 22.

The FTLs 24, 26 are typically fabricated from a carbon fiber paper or non-woven material or woven cloth. Depending on the product construction, the FTLs 24, 26 can have carbon particle coatings on one side. The FTLs 24, 26, as discussed above, can be fabricated to include or exclude a catalyst coating.

In the particular embodiment shown in FIG. 1B, MEA 25 is shown sandwiched between a first edge seal system 34 and a second edge seal system 36. Adjacent the first and second edge seal systems 34 and 36 are flow field plates 40 and 42, respectively. Each of the flow field plates 40, 42 includes a field of gas flow channels 43 and ports through which hydrogen and oxygen feed fuels pass. In the configuration depicted in FIG. 1B, flow field plates 40, 42 are configured as unipolar flow field plates, also referred to as monopolar flow field plates, in which a single MEA 25 is sandwiched there between.

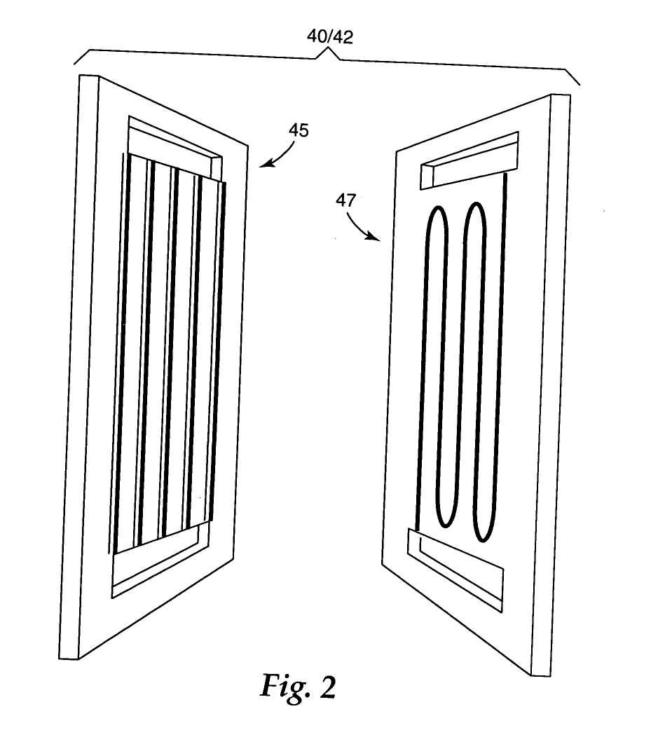

In general terms, and as shown in FIG. 2, a unipolar flow field plate refers to a flow field structure that has a flow field side 47 and a cooling side 45. The flow field side 47, as discussed above, incorporates a field of gas flow channels and ports through which hydrogen or oxygen feed fuels pass. The flow field in this and other embodiments may be a low lateral flux flow field as disclosed in commonly owned co-pending U.S. patent application Ser. No. 09/954,601, filed Sep. 17, 2001, which is incorporated herein by reference.

The cooling side 45 incorporates a cooling arrangement, such as integral cooling channels. Alternatively, the cooling side 45 may be configured to contact a separate cooling element, such as a cooling block or bladder through which a coolant passes or a heat sink element, for example. Various useful fuel cell cooling approaches are described in commonly owned co-pending U.S. Patent Application entitled “Unitized Fuel Cell Assembly and Cooling Apparatus,” Ser. No. 10/295,518, filed on Nov. 15, 2002, which is incorporated herein by reference. The unipolar flow field plates 40, 42 are preferably constructed in accordance with a multi-part molding methodology as described herein.

Returning to FIG. 1B, the edge seal systems 34, 36 provide the necessary sealing within the UCA package to isolate the various fluid (gas/liquid) transport and reaction regions from contaminating one another and from inappropriately exiting the UCA 20, and may further provide for electrical isolation and hard stop compression control between the flow field plates 40, 42. The term “hard stop” as used herein generally refers to a nearly or substantially incompressible material that does not significantly change in thickness under operating pressures and temperatures. More particularly, the term “hard stop” refers to a substantially incompressible member or layer in a membrane electrode assembly (MEA) which halts compression of the MEA at a fixed thickness or strain. A “hard stop” as referred to herein is not intended to mean an ion conducting membrane layer, a catalyst layer, or a gas diffusion layer.

In one configuration, the edge seal systems 34, 36 include a gasket system formed from an elastomeric material. In other configurations, one, two or more layers of various selected materials can be employed to provide the requisite sealing within UCA 20. Such materials include, for example, TEFLON, fiberglass impregnated with TEFLON, an elastomeric material, UV curable polymeric material, surface texture material, multi-layered composite material, sealants, and silicon material. Other configurations employ an in-situ formed seal system, such as those described in commonly owned co-pending U.S. patent application entitled “Unitized Fuel Cell Assembly,” Ser. No. 10/295,292, filed on Nov. 1, 2002 and previously referenced Ser. No. 10/295,518, filed on Nov. 15, 2002, which are incorporated herein by reference.

In another configuration, a gasket arrangement is incorporated into the flow field plates 40, 42 and formed during a molding process. According to one approach, and as discussed in greater detail below, the flow field plates 40, 42 are molded to include a gasket arrangement for the manifolds provided in the flow field plates 40, 42. The gasket arrangement may be formed during molding of the flow field plates 40, 42 or formed during a subsequent molding process. The gasket arrangement may, for example, include one or more raised molded segments of a molded flow field plate 40 or 42. In another approach, one or more channels may be molded into the flow field plates 40, 42 into which one or more gaskets (e.g., o-rings) may be inserted. Such gaskets may each be a closed-cell foam rubber gasket as disclosed in co-pending application Ser. No. 10/294,098, filed Nov. 14, 2002, which is incorporated herein by reference. In other embodiments, and as further discussed below, a gasket arrangement may be molded into the flow field plates 40, 42 with a contact face having a raised-ridge microstructured sealing pattern.

In certain configurations, the gasket system of a separate edge seal system of the type shown in FIG. 1B is not needed. A separate edge seal may be employed in combination with a gasket arrangement molded into or onto the flow field plates 40, 42. Alternatively, the flow field plates 40, 42 may be formed or subsequently processed to provide edge sealing in addition to incorporating a manifold gasket arrangement, thereby obviating the need for separate edge seal systems of the type shown in FIG. 1B.

FIG. 1C illustrates a UCA 50 which incorporates multiple MEAs 25 through employment of unipolar flow field plates and one or more bipolar flow field plates 56. In the configuration shown in FIG. 1C, UCA 50 incorporates two MEAs 25a and 25b and a single bipolar flow field plate 56. MEA 25a includes a cathode 62a/membrane 61a/anode 60a layered structure sandwiched between FTLs 66a and 64a. FTL 66a is situated adjacent a flow field end plate 52, which is configured as a unipolar flow field plate. FTL 64a is situated adjacent a first flow field surface 56a of bipolar flow field plate 56.

Similarly, MEA 25b includes a cathode 62b/membrane 61b/anode 60b layered structure sandwiched between FTLs 66b and 64b. FTL 64b is situated adjacent a flow field end plate 54, which is configured as a unipolar flow field plate. FTL 66b is situated adjacent a second flow field surface 56b of bipolar flow field plate 56. It will be appreciated that N number of MEAs 25 and N-1 bipolar flow field plates 56 can be incorporated into a single UCA 50. It is believed, however, that, in general, a UCA 50 incorporating one or two MEAs 56 (N=1, bipolar plates=0 or N=2, bipolar plates=1) is preferred for more efficient thermal management. As discussed previously, a bipolar plate or plates of a UCA may be constructed according to a multi-part molding methodology of the present invention or may be of a conventional construction.

The UCA configurations shown in FIGS. 1B and 1C are representative of two particular arrangements that can be implemented for use in the context of the present invention. These two arrangements are provided for illustrative purposes only, and are not intended to represent all possible configurations coming within the scope of the present invention. Rather, FIGS. 1B and 1C are intended to illustrate various components that can be selectively incorporated into a unitized fuel cell assembly packaged in accordance with the principles of the present invention.

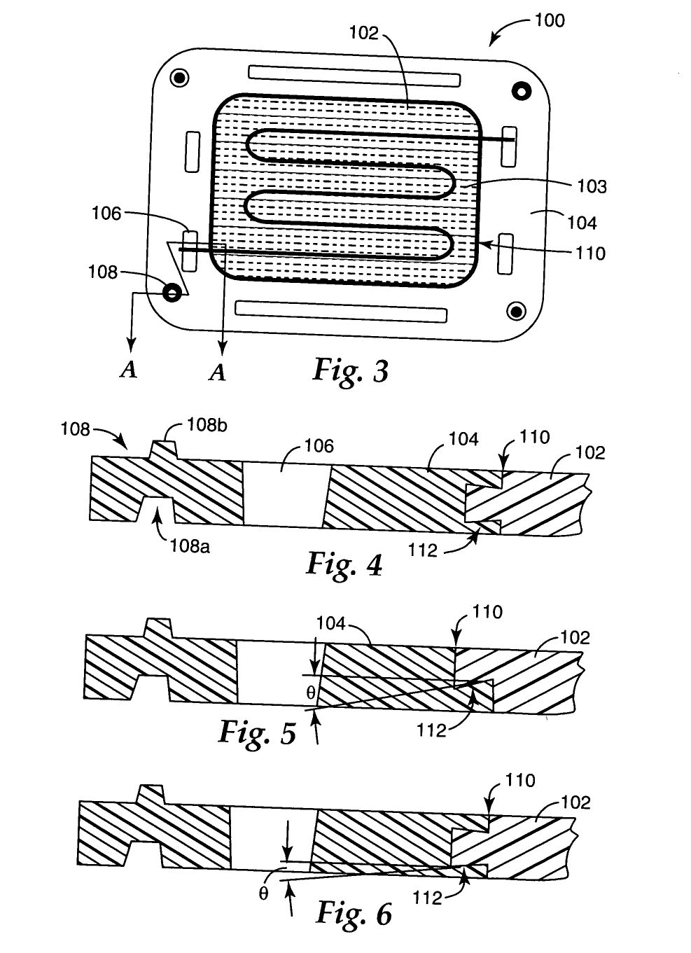

FIG. 3 illustrates an embodiment of a flow field structure in accordance with the present invention. FIG. 3 shows a flow field structure 100 having a unipolar configuration. The flow field structure 100 according to this embodiment is a multi-part structure that includes a flow field plate 102 and a frame 104. The flow field plate 102 is formed of a conductive material and the frame 104 is formed of a non-conductive material. The flow field plate 102 and frame 104 are molded structures preferably formed from polymer materials. The polymer materials may be similar in character or dissimilar.

For example, the flow field plate 102 and frame 104 can be formed from the same base resin or different resins. It is believed that, by using dissimilar materials for the flow field plate 102 and frame 104, the materials with the best properties and lowest cost can be used for each functional area of the flow field structure 100. A non-limiting, non-exhaustive listing of suitable materials includes elastomeric materials, thermosetting and thermoplastic materials. The frame preferably is made of epoxy, urethane, acrylate, polyester or polypropylene while the flow field plate is made of these same materials or high temperature resins such as polyetheretherketone (PEEK), polyphenylene sulfide, polyphenylene oxide. Most preferably the frame is made of an elastomer such as a thermoplastic urethane (TPU) and the flow field plate is made of injection moldable grade graphite filled thermoplastic. In one illustrative configuration, the flow field plate 102 may be formed from a thermosetting material that is highly loaded with conductive filler, such as a graphite or other carbonaceous conductive filler. The frame 104 may be formed from a thermoplastic material. In another illustrative configuration, both the flow field plate 102 and the frame are formed from a thermoplastic base material.

The flow field structure 100 may be molded using one or a combination of molding techniques. Moreover, the flow field plate 102 and the frame 104 may be molded in the same molding machine or different molding machines. Further, the flow field plate 102 and the frame 104 may be molded in a common molding machine contemporaneously, such as by molding the flow field plate 102 via a first material shot followed shortly thereafter by molding the frame 104 via a second material shot. The first and second shots may occur in the same molding machine or different machines. Also, the first and second shots may occur in the same molding machine without opening the mold between the first and second shots.

A number of molding techniques may be employed and adapted for use in molding a multi-part flow field structure 100 of the present invention. Such molding techniques include compression molding, injection molding, transfer molding, and compression-injection molding, for example. According to one approach, the flow field plate 102 may be formed using a compression molding technique, while the frame 104 may be formed using an injection molding technique. Preferably, both the flow field plate 102 and the frame 104 may be formed using an injection molding technique.

By way of example, a highly filled material may be compression molded to form the flow field plate 102. Once formed, the flow field plate 102 may be transferred robotically or through manual assistance to an injection mold as an insert. The frame 104 may be injected molded around the flow field plate insert. In another approach, a highly filled material may be injection molded to form the flow field plate 102. A material that is not filled may then be injection molded around the flow field plate 102 to form the frame 104. This may be performed in the same mold or different molds.

In yet another approach, a two-shot method within a common mold is employed. One material is injection molded in a first shot to form one of the flow field plate 102 and frame 104, and a second material is injection molded in a second shot to form the other of the flow field plate 102 and frame 104. The second material shot may be delivered after the first material shot is nearly cured. The mold may or may not be opened between the first and second material shots.

FIGS. 4-6 illustrate various features that may be incorporated into a molded flow field structure of the present invention. FIGS. 4-6 are sectional views of a portion of the flow field plate 102 and frame 104 taken at section A-A shown in FIG. 3. It is understood that in some embodiments, all of the features illustrated in FIGS. 4-6 may be incorporated into a molded flow field structure. In other embodiments, less that all of the depicted features may be incorporated into a molded flow field structure of the present invention.

FIG. 4 shows several advantageous features that may be molded into the flow field plate 102 and frame 104 of a flow field structure 100. A manifold 106 defines a void in the frame 104 through which fuel or oxygen pass. A registration arrangement 108 is shown molded as part of the frame 104. The registration arrangement 108 may be configured to provide one or both of inter-cell and intra-cell registration.

For example, an intra-cell feature of the registration arrangement 108 provides for alignment of at least two components of a given fuel cell assembly or UCA. An inter-cell feature of the registration arrangement 108 provides for alignment of at least one component of a given fuel cell assembly or UCA with at least one component of an adjacent fuel cell assembly or UCA. It is noted that a registration arrangement 108 can include one or more features that provide for both inter-cell and intra-cell registration. Use of a molded registration arrangement advantageously obviates the secondary assembly process of inserting registration posts into corresponding registration apertures during fuel cell component assembly.

For example, and as shown in FIG. 4, the registration arrangement 108 includes a registration post 108b and a registration recess 108a. The registration post 108b is configured to be received by a registration recess 108a of an adjacent flow field structure 100 or end plate of a flow field stack assembly. The registration recess 108a is configured to receive a registration post 108b of an opposing flow field structure 100 of the subject UCA. In one configuration, an MEA (not shown) of a UCA is fabricated to include registration apertures dimensioned to permit passage of a registration post 108b. The registration posts 108b of a first flow field structure 100 align with, and pass through, the registration apertures provided in the MEA. The registration posts 108b of the first flow field structure 100 are received by registration recesses 108a of a second flow field structure 100 of the UCA. The registration posts 108b of the second flow field structure 100 protrude from UCA. Having assembled a first UCA in this fashion, another UCA may be assembled adjacent to the first UCA by mating engagement of the registration posts 108b of the first UCA with registration recesses 108a of the next UCA.

It is noted that the presence (or absence) of the protruding registration posts 108b from a flow field structure of an assembled UCA can provide a visually perceivable positioning and polarity identification feature for adding another UCA to a fuel cell stack. The presence of protruding registration posts 108b, for example, is readily discernable from the presence of registration recesses 108a. Depending on the particular identification convention adopted, the anode or cathode plate of each fuel cell assembly may be identified by the presence of registration posts 108b, for example. The other of the anode and cathode plate may be identified by the presence of registration recesses 108a.

In one embodiment, the registration posts 108b and recesses 108a may have the same peripheral shape, such that a contact interface between the registration posts 108b and recesses 108a defines a substantially continuous press-fit interface. According to another embodiment, each of the registration posts 108b has an outer surface differing in shape from a shape of the inner surface of the registration recesses 108a. The inner surface of the registration recesses 108a contacts the outer surface of the registration posts 108b at a plurality of discrete press-fit locations.

In one configuration, the shape of at least one of the inner surface of the registration recesses 108a and the outer surface of the registration posts 108b may, for example, define a convex curved shape. The shape of at least one of the inner surface of the registration recesses 108a and the outer surface of the registration posts 108b may also define a generally curved shape comprising a two or more concave or protruding portions. In another configuration, the shape of at least one of the inner surface of the registration recesses 108a and the outer surface of the registration posts 108b may define a circular or an elliptical shape. For example, the shape of one of the inner surface of the registration recesses 108a and the outer surface of the registration posts 108b may define a circle, and the shape of the other of the inner surface of the registration recesses 108a and the outer surface of the registration posts 108b may define an ellipse.

Other shape relationships are possible. For example, the shape of at least one of the inner surface of the registration recesses 108a and the outer surface of the registration posts 108b may define a polygon. The shape of one of the inner surface of the registration recesses 108a and the outer surface of the registration posts 108b, for example, may define a first polygon, and the shape of the other of the inner surface of the registration recesses 108a and the outer surface of the registration posts 108b may define a second polygon. By way of further example, the shape of one of the inner surface of the registration recesses 108a and the outer surface of the registration posts 108b may define a polygon, and the shape of the other of the inner surface of the registration recesses 108a and the outer surface of the registration posts 108b may define a circle or an ellipse. The shape of the inner surface of the registration recesses 108a may also define a triangle, and the outer surface of the registration posts 108b may define a circle. Other illustrative registration post configurations include those having a tapered shape or a wedge shape. Additional details of useful fuel cell registration arrangements are disclosed in commonly owned co-pending U.S. patent application entitled “Registration Arrangement for Fuel Cell Assemblies,” Ser. No. 10/699,454, filed on Oct. 31, 2003, which is incorporated herein by reference.

With continued reference to FIG. 4, a joint 110 is shown formed between the frame 104 and the flow field plate 102. The joint 110 is formed to provide a seal between the frame 104 and the flow field plate 102. In one configuration, sealing of the joint 110 is provided by preferential shrinkage of one or both of the frame and flow field plate materials during the molding process. For example, the frame 104 may be molded around the flow field plate 102 and have shrinkage properties that facilitate formation of an air-tight seal between the frame 104 and flow field plate 102.

As is shown in FIG. 4, for example, the non-conductive polymer of the frame 104 has a directional shrinkage property that results in preferential shrinkage of the frame 104 material directed inwardly toward the flow field plate 102. The shrinkage properties of the frame 104 can be controlled by, for example, doping the polymer with an appropriate type and amount of filler, such as glass beads or suitable minerals. The shrinkage properties of the frame 104 are preferably controlled to provide the requisite sealing at the joint 110, while minimizing undesirable warpage (e.g., oil-canning) of the frame 104. Those skilled in the art will appreciate that other factors will influence the shrinkage characteristics of the materials used to form the flow field structure 100, such as mold temperatures, curing time, injection pressure, and hold pressure.

The joint 110 preferably incorporates an engagement arrangement that provides a sound mechanical interface between the frame 104 and flow field plate 102. In the configuration shown in FIG. 4, the joint 110 incorporates an interlocking arrangement formed between the frame 104 and flow field plate 102 as part of the molding process. In one approach, a first feature of the interlocking arrangement is molded about the outer periphery of the flow field plate 102. A second feature of the interlocking arrangement is molded about the inner periphery of the plate 104. The molded first and second features provide for mechanical interlocking between the frame 104 and flow field plate 102.

FIGS. 5 and 6 illustrate two configurations of an interlocking arrangement at the joint 110. FIG. 5 shows a partial dovetail interlocking arrangement formed by inclusion of a backdraft angle, θ, in the molded outer periphery of the flow field plate 102. When the material of the frame 104 is shot around the flow field plate 102, the frame material flows around the backdraft region of the outer periphery of the flow field plate 102 to create an interlocking arrangement between the flow field plate 102 and frame 104. FIG. 6 shows a full dovetail interlocking arrangement formed by inclusion of a backdraft angle, θ, at two backdraft regions in the molded outer periphery of the flow field plate 102. It is noted that the backdraft angle, θ, shown in FIG. 6 is less than that of FIG. 5, since the interlocking arrangement of FIG. 6 incorporates two backdraft regions, while that of FIG. 5 incorporates a single backdraft region.

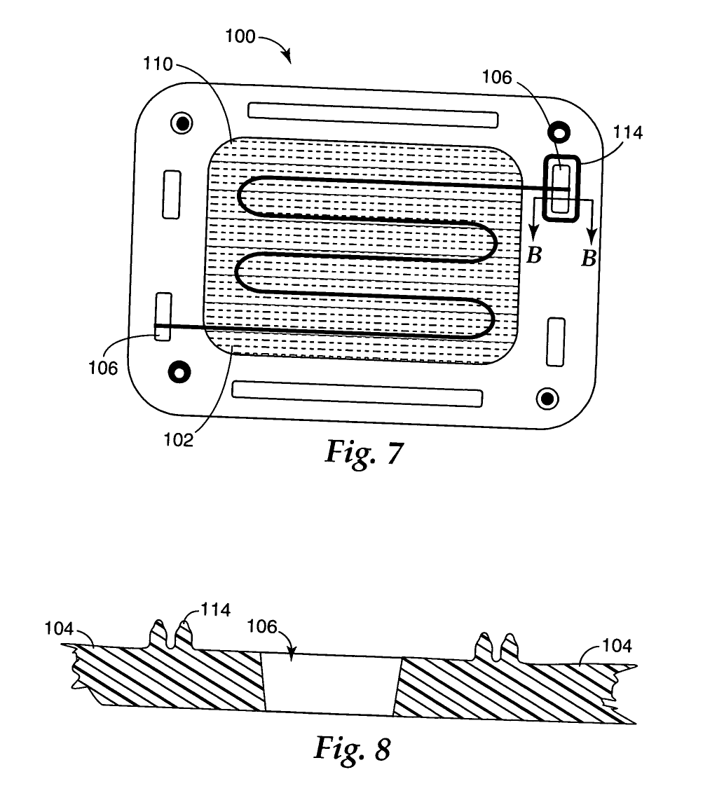

FIGS. 7 and 8 illustrate a gasket arrangement according to an embodiment of the present invention. FIG. 7 is a view of the flow field side of a flow field structure 100 that incorporates a molded gasket arrangement 114. A fuel or oxygen manifold 106 is shown in FIG. 7. For purposes of illustration, a flow channel is shown progressing through the flow field plate 102 and terminating at fuel inlet and outlet manifolds 106. FIG. 8 is an exploded sectional view of a portion of the frame 104 taken across section B-B shown in FIG. 7.

The gasket arrangement 114 is formed as one or more ridges protruding from a surface of the frame 102. In FIG. 8, the gasket arrangement 114 is shown to include double ridges of molded material, it being understood that a single ridge or more than two ridges may be molded to form the gasket arrangement 114. In one configuration, as is shown in FIG. 7, a gasket arrangement 114 is molded around the periphery of each of the manifolds 106. In another configuration, a common gasket arrangement 114 (two single or a multiple ridged gasket) may be formed around all of the manifolds 106.

According to one approach, the gasket arrangement 114 is formed during molding of the frame 104. In another approach, the gasket arrangement 114 is molded to a previously formed frame 104 in a subsequent molding process. Molding the gasket arrangement 114 in a molding process separate from the frame 104 allows for greater selectivity of materials for the various functional regions of a flow field structure 100. For example, in certain applications, it may be desirable to form the gasket arrangement 114 using the same material as is used to form the frame 104. In other applications, it may be desirable to form the gasket arrangement 114 using a material dissimilar to that used to form the frame 104. For example, the polymeric material used to mold the gasket arrangement 114 to the frame 104 may have a hardness less than that of the frame material. Molding the flow field plate 102, frame 104, and gasket 114 using materials that are optimal for these components provides the opportunity to produce a flow field structure 100 that can be designed for use in a wide range of applications, and further provides the opportunity to more effectively balance performance and cost requirements.

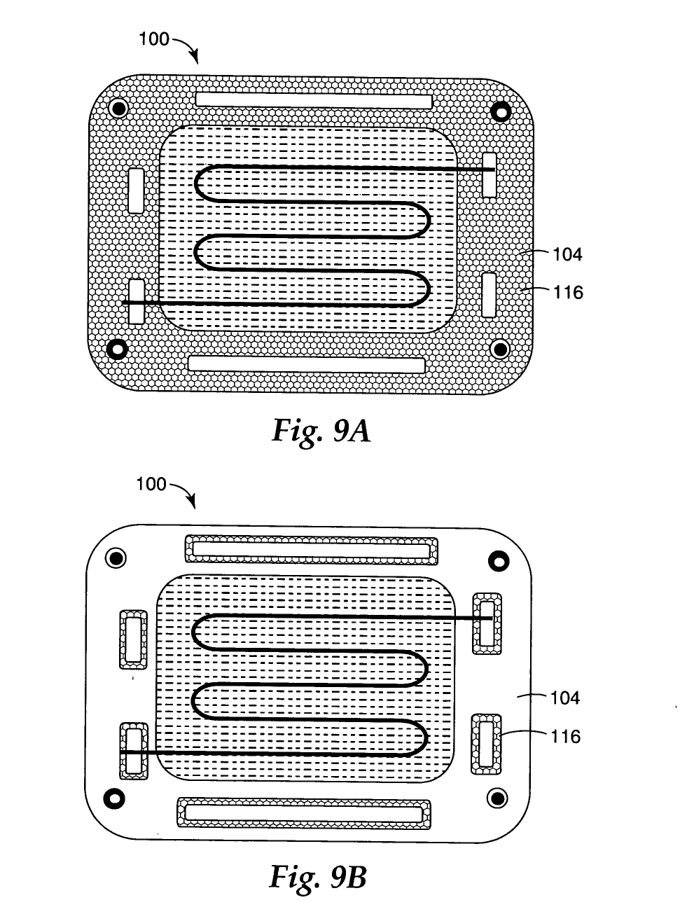

FIGS. 9A and 9B illustrate another embodiment of a gasket arrangement in accordance with the present invention. According to this embodiment, the gasket arrangement 114 comprises a microstructured sealing pattern formed on the frame 104. As is shown in FIG. 9A, a microstructured sealing pattern 116 may be developed on all or nearly all of the surface of the frame 104. As is shown in FIG. 9B, a microstructured sealing pattern 116 may be developed at selected surface portions of the frame 104. For example, a microstructured sealing pattern 116 may be provided around the manifolds of the frame 104, such as the manifolds 106 used for passing fuels and coolant into and out of a fuel cell assembly.

According to one embodiment, the microstructured sealing pattern 116 comprises a raised-ridge microstructured contact pattern. In this configuration, the raised-ridge microstructured contact pattern preferably incorporates a hexagonal pattern, which may include a degenerate hexagonal pattern, for example. The raised-ridge microstructured contact pattern may, in general, comprise ridges that meet at joining points, wherein no more than three ridges meet at any one joining point. The raised-ridge microstructured contact pattern is typically composed of cells so as to localize and prevent spread of any leakage.

By way of non-limiting example, the ridges that comprise the raised-ridge microstructured contact pattern may have an unladen width of less than 1,000 micrometers, more typically less than 600 micrometers, and most typically less than 300 micrometers, and typically have a depth (height) of no more than 250 micrometers, more typically less than 150 micrometers, and most typically less than 100 micrometers. The microstructure sealing pattern 116 shown in FIGS. 9A and 9B may be formed in a manner described in commonly owned co-pending U.S. patent application Ser. No. 10/143,273, filed May 10, 2002, which is incorporated herein by reference. A multicavity mold could also be used wherein a coupling arrangement is molded between the cavities of the multicavity mold.

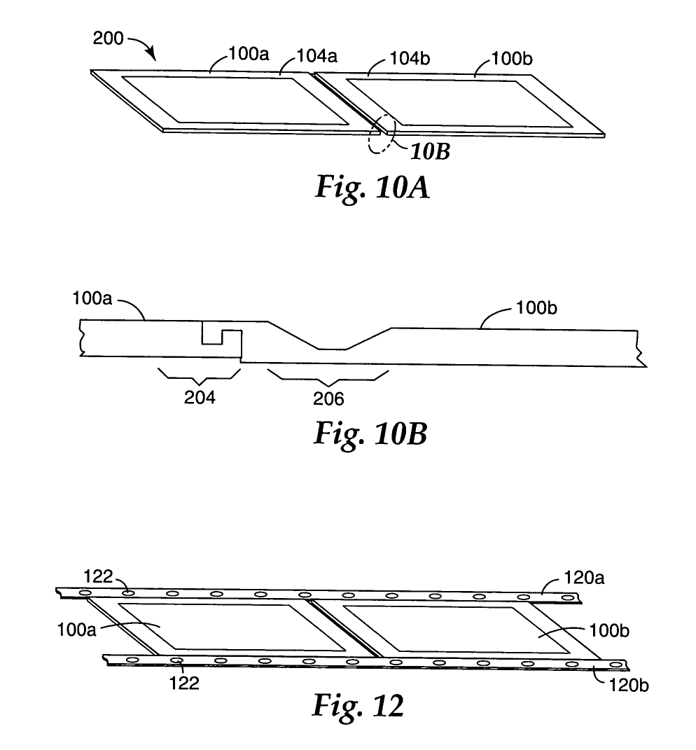

FIGS. 10A-14B illustrate various embodiments of flow field structures that incorporate a coupling arrangement to facilitate production of a web of such flow field structures. Molding flow field structures to include a coupling arrangement of the type illustrated in FIGS. 10A-14B provides for mass production of flow field structures that are suitable for winding as a roll-good. A roll-good of flow field structures may be used in an automated process for producing UCAs, as will be described below. A coupling arrangement for molded flow field structures of the present invention may incorporate one or more of a living hinge, carrier strip, or other interlocking arrangement, such as a tapered hole and plug arrangement, provided to connect a number of flow field structures together.

In FIGS. 10A and 10B, there is illustrated a segment of a web 200 of flow field structures 100a, 100b. The two flow field structures 100a, 100b depicted in FIG. 10A are preferably of a type previously described. A coupling arrangement is shown connecting together the two flow field structures 100a, 100b. In general, the coupling arrangement may be formed by material molded or overmolded between a given flow field structure 100a and a previously molded flow field structure 100b. Repeated formation of a coupling arrangement between a number of molded flow field structures provides for the production of a continuous web of flow field structures.

FIG. 10B is an exploded view of the coupling arrangement shown in FIG. 10A. The coupling arrangement includes an overmold region 204 that is formed between respective frames 104a, 104b of adjacently situated flow field structures 100a, 100b. In the configuration shown in FIG. 10B, the coupling arrangement incorporates interlocking flanges formed between adjacent frames 104a, 104b. In one approach, the overmold region 204 is formed by molding a first L-shaped flange along all or a portion of a first frame 104a. A second L-shaped flange of a second molded frame 104b is subsequently formed by overmolding material from the second frame 104b into the region of the first L-shaped flange. Overmolding the second L-shaped flange onto the first L-shaped flange provides for formation of a coupling arrangement between adjacent flow field structures 100a, 100b.

The coupling arrangement shown in FIG. 10B further includes a living hinge 206. The living hinge 206 shown in FIG. 10B defines a depression in the material connecting frames 104a, 104b of adjacent flow field structures 100a, 100b. Inclusion of the living hinge 206 provides for enhanced flexibility of a web of flow field structures and facilitates subsequent singulation of individual flow field structures from the web. It is noted that the coupling arrangement shown in FIGS. 10A and 10B may be continuous across all or a portion of the frames 104a, 104b. It is further noted that the coupling arrangement is typically formed of the same material as the frames 104a, 104b, but may also by formed using a material dissimilar to that of the frames 104a, 104b. For example, the coupling arrangement may be formed between two molded frames 104a, 104b using a material having properties differing from that of the frames 104a, 104b (e.g., greater flexibility).

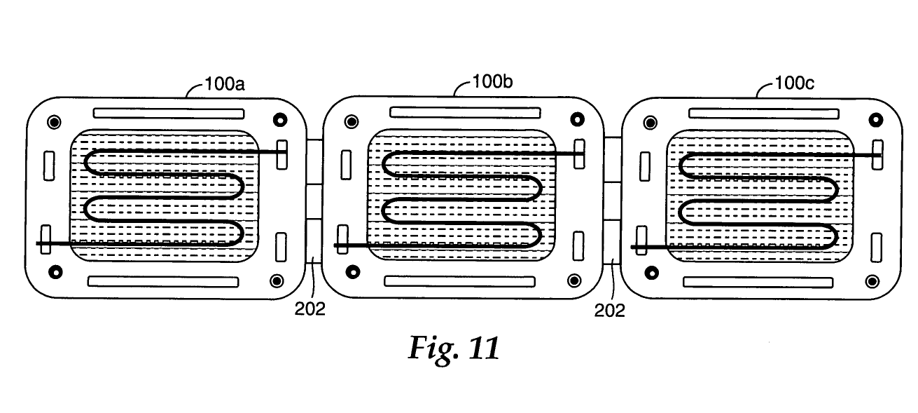

FIG. 11 illustrates a tab 202 in accordance with another embodiment of the present invention. According to this embodiment, a number of discrete tabs 202 are formed between the frames of adjacent flow field structures 100a, 100b, 100c. Each of the tabs 202 shown in FIG. 11 may include one or both of an interlocking overmold region 204 and living hinge 206 of the type shown in FIG. 10B.

FIG. 12 illustrates another embodiment of a coupling arrangement in accordance with the present invention. In this embodiment, carrier strips 120a, 120b are formed to connect adjacent flow field structures in a continuous web. In one approach, the frames for the flow field structures 100a, 100b and the carrier strips 120a, 120b are formed in the mold using the same shot, with continuous or discrete connecting material formed between the frames of the flow field structures 100a, 100b and the carrier strips 120a, 120b.

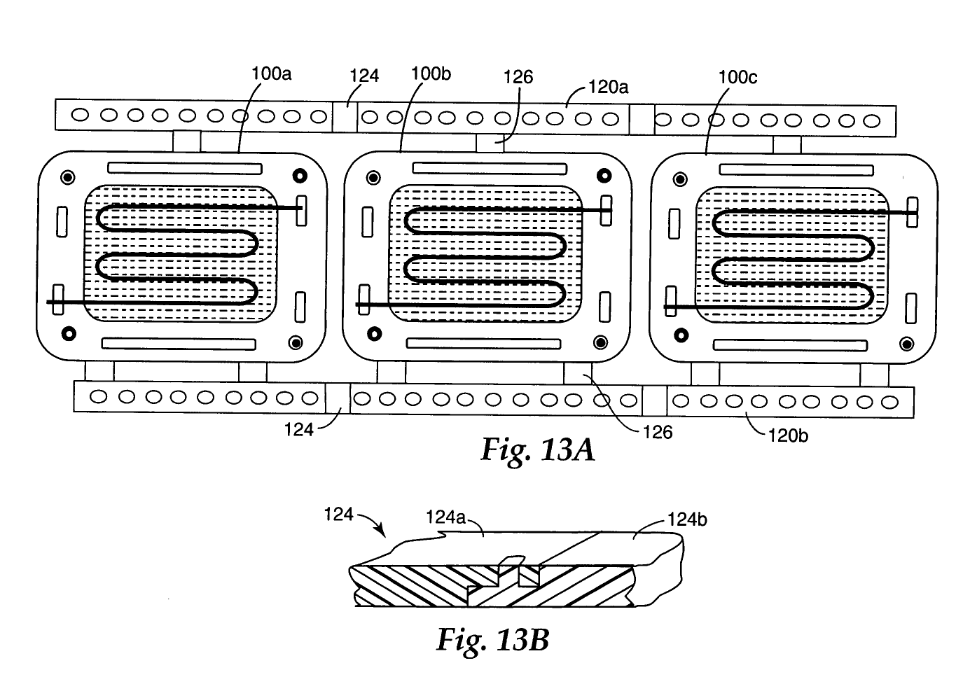

FIGS. 13A and 13B illustrate details of another coupling arrangement that includes carrier strips 120a, 120b. In one approach, each of the frames for the flow field structures 100a, 100b, the carrier strips 120a, 120b, and connection tabs 126 (formed between the frames of flow field structures 100a, 100b and carrier strips 120a, 120b) is formed in the mold using the same shot. In another approach, the frames for the flow field structures 100a, 100 and the carrier strips 120a, 120b are formed using the same shot, but after this first shot, a narrow gap separates the flow field structures 100a, 100b and carrier strips 120a, 120b. A second overmold shot injects material into this narrow gap to form connecting tabs 126 between the frames of the flow field structures 100a, 100b and the carrier strips 120a, 120b. The connecting tabs 126 may be formed using the same or different material as that used to form the frames of the flow field structures 100a, 100b.

The carrier strips 120a, 120b may be formed to incorporate an overmold region 124, an exploded view of which is provided in FIG. 13B. The overmold region 124 includes an interlocking arrangement formed between edge features of adjacently molded carrier strips 124a, 124b. FIG. 13B shows one of many possible interlocking arrangements that may be formed by overmolding carrier strips 124a and 124b.

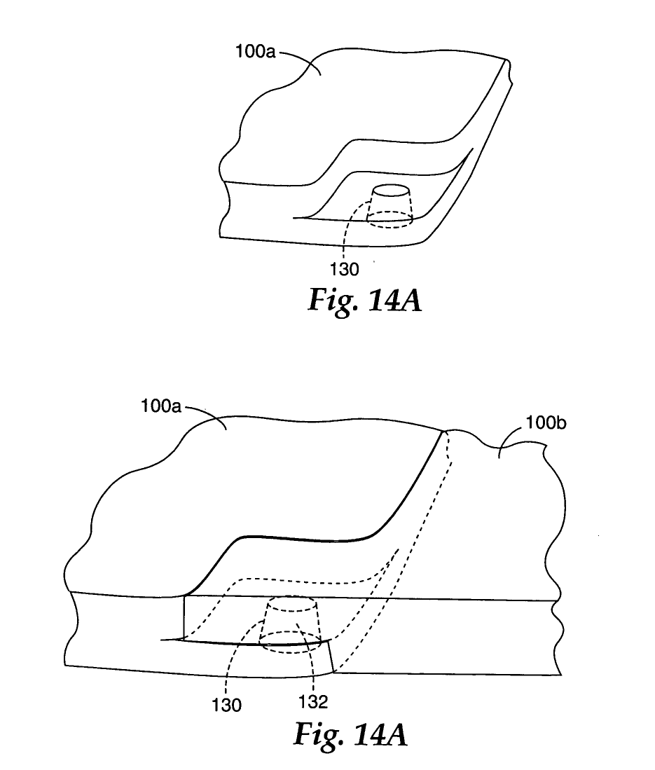

FIGS. 14A and 14B illustrate yet another approach to molding flow field structures to form a continuous web. According to this approach, a reverse taper hole 130 is molded into a corner of a first flow field structure 100a during a first shot. During a second overmold shot that forms an adjacent flow field plate 100b, material from the second shot is flowed into at least the reverse taper hole 130 of the previously molded plate 100a to form a plug 132. This hold and plug interlocking arrangement can be formed at each corner of adjacent flow field structures 100a, 100b.

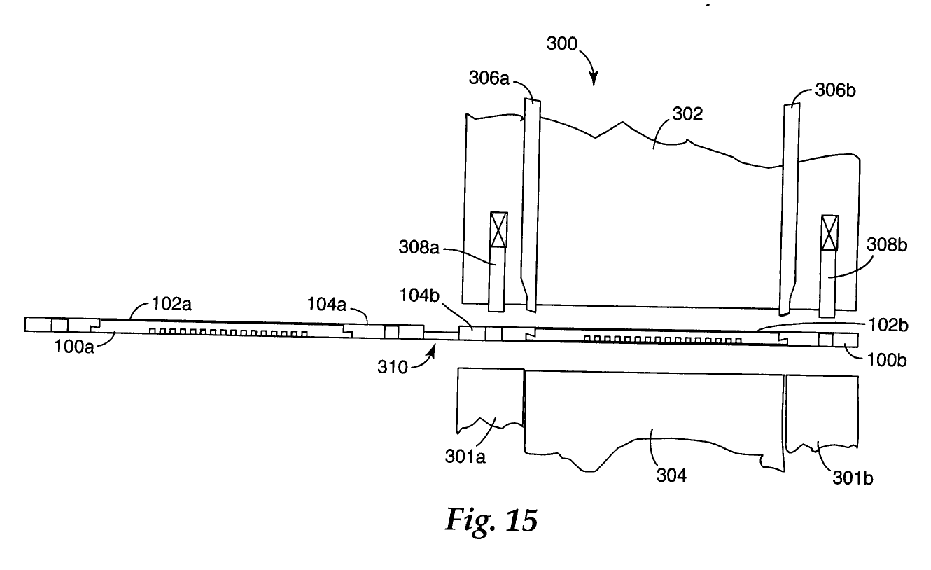

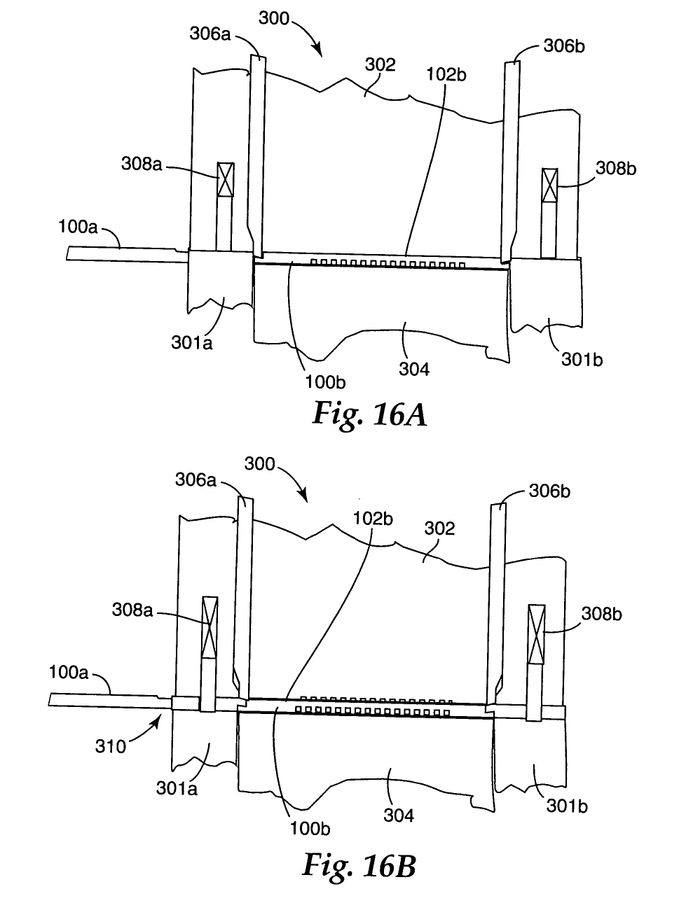

FIGS. 15-16B illustrate a molding process well suited for producing a web of flow field structures in accordance with the present invention. FIG. 15 shows a portion of a mold 300 that includes an upper mold half 302 and a lower mold half 304. The respective mold halves 302, 304 include movable features that facilitate molding of both the conductive flow field plate and non-conductive frame in a single molding machine. Moreover, the moveable features facilitate molding of both the conductive flow field plate and non-conductive frame in consecutive shots without opening the mold. It will be understood that the mold and process described with reference to FIGS. 15-16B are provided for illustration only, and that other mold configurations and processes may be used. For example, multiple molding machines may be used to mold different components of the flow fields structure and coupling arrangements to produce a web of flow field structures.

Returning to FIG. 15, the upper mold half 302 includes vertically displaceable cores 306a, 306b and spring loaded cores 308a, 308b. The lower mold half 304 includes vertically displaceable slides 301a, 301b. The slides and cores of the upper and lower mold halves 302, 304 are actuated in a coordinated manner to produce the flow field plate 102b in a first shot of conductive material and the frame 104b in a second shot of non-conductive material. During the second shot (or a third shot), a coupling arrangement 310 is formed that connects the frame 104b of the currently molded flow field structure 100b with the frame 104a of the previously molded flow field structure 100a.

As was discussed previously, the coupling arrangement 310 includes an overmold region that forms an interlocking arrangement and may also include a living hinge (see, e.g., FIG. 10B). It is noted that the mold details for forming the coupling arrangement 310 are not shown in FIGS. 15-16B for simplicity. It is further noted that mold structures proximate the entrance to the mold 300 are also not shown for purposes of simplicity. These mold structures, however, would readily be appreciated by one skilled in the art.

FIGS. 16A and 16B illustrate first and second shots of a molding process in which a flow field structure and frame are molded in a single molding machine and preferably without opening the mold between material shots. In FIG. 16A, it is assumed that a previous multi-part flow field structure 100a has previously been molded and the next adjacent flow field structure 100b is presently being molded. With the mold 300 in a closed orientation, cores 306a, 306b are displaced from the upper mold half 304 toward the lower mold half 304. The spring loaded cores 308a, 308b are in a retracted position in response to force produced by the upward positioning of the slides 301 a, 301b from the lower mold half 304. With the cores 306a, 306b and slides 301a, 301b in position as shown in FIG. 16A, conductive material is injected into the mold cavity to form the flow field plate 102b. Note that the positioning of cores 306a, 306b and slides 301 a, 301b as shown in FIG. 16A results in formation of half of the interlocking joint that is formed between the flow field plate 102b and frame 104b.

After completion of the first shot and expiration of an appropriate curing duration, the slides 306a, 306b are upwardly displaced to a position coplanar with respect to the upper surface of the flow field plate 102b. The slides 301a, 301b are downwardly displaced so that upper surfaces of the slides 301a, 301b are coplanar with respect to a lower surface of the flow field plate 102b. Downward movement of the slides 301a, 301b permit the spring loaded cores 308a, 308b to move to a downward position as shown in FIG. 16B. After repositioning the slides 306a, 306b, 301a, 301b to positions shown in FIG. 16B, a second shot of non-conductive material is delivered to the mold cavity. The second shot results in formation of the frame 104b, completion of the interlocking joint between the frame 104a and the flow field plate 102b, and formation of the manifolds via the spring loaded cores 308a, 308b. During the second shot, formation of the coupling arrangement 310 is also completed.

After completion of the second shot and expiration of an appropriate curing duration, the mold halves 302, 304 separate, and the multi-part molded flow field structure 102b is separated from the mold cavity and moved robotically or through manual assistance into a staging position adjacent the exit of the mold cavity. The slides and cores of the mold 300 are moved to appropriate positions and another multi-part flow field structure is molded in a manner described above. In this manner, a continuous web of molded flow field structures may be produced. This web may be subject to a winding operation to produce a roll-good of flow field structures.

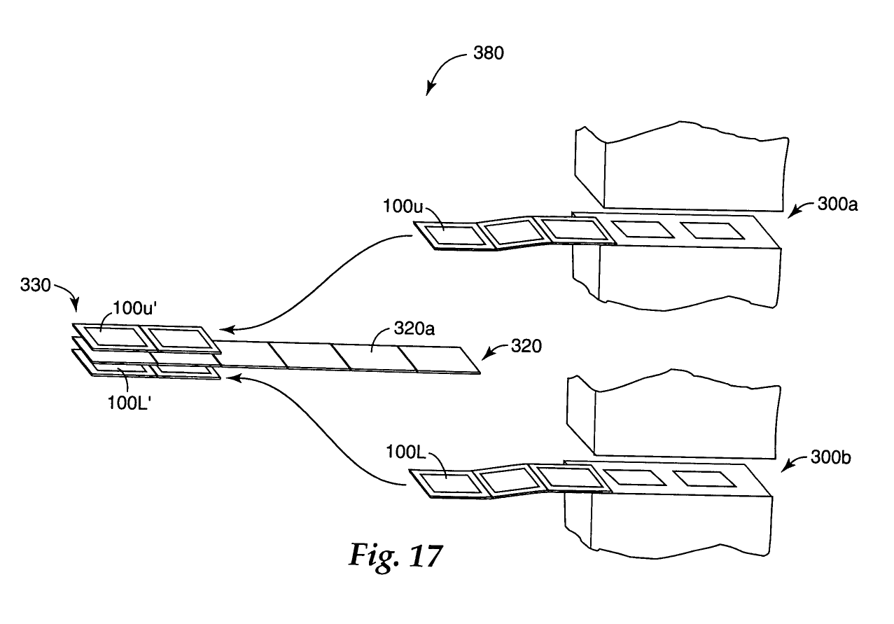

A web of flow field structures produced in accordance with the present invention can be rolled up as a roll-good for future use in a fuel cell assembly operation. Alternatively, and as shown in FIG. 17, webs of flow field structures can be fed directly into a UCA assembly line 380, in which case two molding machines 300a, 300b may be used, each making a web of unipolar flow field structures in a manner described above. A roll-good fuel cell web that incorporates individual MEAs (MEA web) may be produced in a manner described in commonly owned co-pending U.S. Patent Application entitled “Roll-Good Fuel Cell Fabrication Processes, Equipment, and Articles Produced From Same,” Ser. No. 10/446485, filed on May 28, 2003, which is incorporated herein by reference.

In general, an MEA web 320 is transported so that individual MEAs 320a of the MEA web 320 register with a pair of flow field structures 100u′, 100L′ from the first and second flow field plate webs 100u, 100L. After encasing the MEAs 320a between respective pairs of flow field structures 100u′, 100L′, the resulting UCA web 330 may be further processed by a sealing station and/or a winding station. A web 330 of sealed UCAs can subsequently be subject to a singulation process to separate individual UCAs from the UCA web 330.

It is noted that the UCA configurations shown in various Figures and discussed herein are representative of particular arrangements that can be implemented for use in the context of the present invention. These arrangements are provided for illustrative purposes only, and are not intended to represent all possible configurations coming within the scope of the present invention. For example, a molding process for producing flow field structures as described above may dictate use of certain UCA features, such as additional or enhanced sealing features, gasket features, and/or hard and soft stop features. Conversely, such a molding process may provide for elimination of certain UCA features, such as elimination of a separate gasket or sealing feature by substitute use of material molded around the manifolds and/or edge portions of the flow field structures.

A variety of UCA configurations can be implemented with a thermal management capability in accordance with other embodiments of the present invention. By way of example, a given UCA configuration can incorporate an integrated thermal management system. Alternatively, or additionally, a given UCA can be configured to mechanically couple with a separable thermal management structure. Several exemplary UCA thermal management approaches are disclosed in previously incorporated U.S. patent application Ser. Nos. 10/295,518 and 10/295,292.

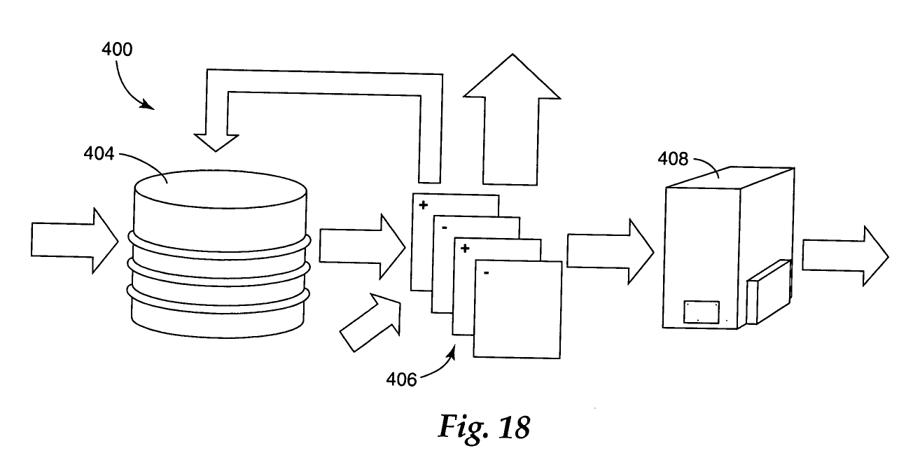

FIGS. 18-21 illustrate various fuel cell systems for power generation that may incorporate fuel cell assemblies having molded multi-part flow field structures as described herein. The fuel cell system 400 shown in FIG. 18 depicts one of many possible systems in which a fuel cell assembly as illustrated by the embodiments herein may be utilized.

The fuel cell system 400 includes a fuel processor 404, a power section 406, and a power conditioner 408. The fuel processor 404, which includes a fuel reformer, receives a source fuel, such as natural gas, and processes the source fuel to produce a hydrogen rich fuel. The hydrogen rich fuel is supplied to the power section 406. Within the power section 406, the hydrogen rich fuel is introduced into the stack of UCAs of the fuel cell stack(s) contained in the power section 406. A supply of air is also provided to the power section 406, which provides a source of oxygen for the stack(s) of fuel cells.

The fuel cell stack(s) of the power section 406 produce DC power, useable heat, and clean water. In a regenerative system, some or all of the byproduct heat can be used to produce steam which, in turn, can be used by the fuel processor 404 to perform its various processing functions. The DC power produced by the power section 406 is transmitted to the power conditioner 408, which converts DC power to AC power for subsequent use. It is understood that AC power conversion need not be included in a system that provides DC output power.

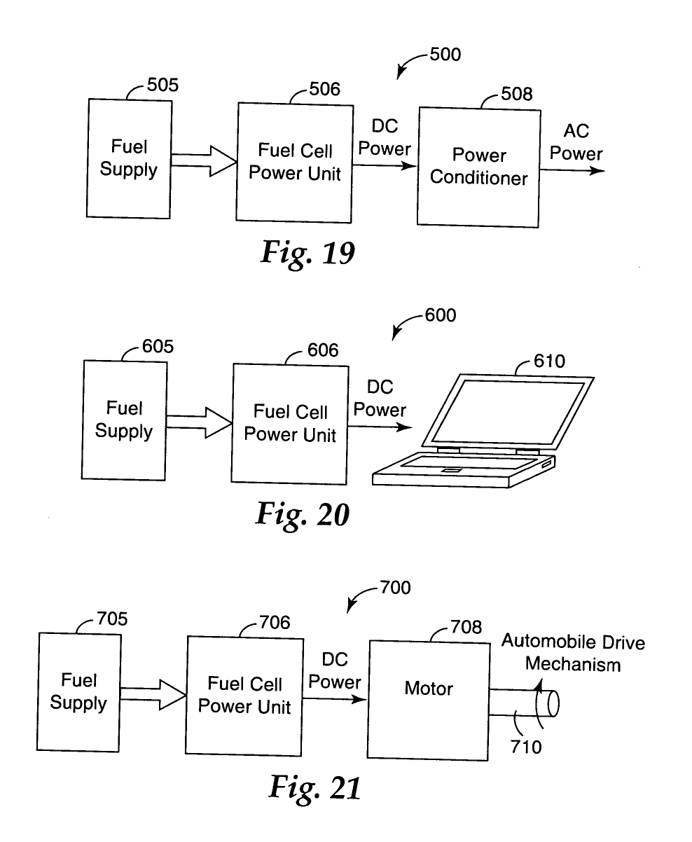

FIG. 19 illustrates a fuel cell power supply 500 including a fuel supply unit 505, a fuel cell power section 506, and a power conditioner 508. The fuel supply unit 505 includes a reservoir that contains hydrogen fuel which is supplied to the fuel cell power section 506. Within the power section 506, the hydrogen fuel is introduced along with air or oxygen into the UCAs of the fuel cell stack(s) contained in the power section 506.

The power section 506 of the fuel cell power supply system 500 produces DC power, useable heat, and clean water. The DC power produced by the power section 506 may be transmitted to the power conditioner 508, for conversion to AC power, if desired. The fuel cell power supply system 500 illustrated in FIG. 19 may be implemented as a stationary or portable AC or DC power generator, for example.

In the implementation illustrated in FIG. 20, a fuel cell system 600 uses power generated by a fuel cell power supply to provide power to operate a computer. The fuel cell power supply system includes a fuel supply unit 605 and a fuel cell power section 606. The fuel supply unit 605 provides hydrogen fuel to the fuel cell power section 606. The fuel cell stack(s) of the power section 606 produce power that is used to operate a computer 610, such as a desk top, laptop, or palm computer.

In another implementation, illustrated in FIG. 21, power from a fuel cell power supply is used to operate an automobile 710. In this configuration, a fuel supply unit 705 supplies hydrogen fuel to a fuel cell power section 706. The fuel cell stack(s) of the power section 706 produce power used to operate a motor 708 coupled to a drive mechanism of the automobile 710.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A flow field structure for use in a fuel cell assembly, comprising:
a molded flow field plate formed of a conductive material comprising a first polymer;
a molded frame disposed around the flow field plate and formed of a non-conductive material comprising a second polymer, the molded flow field plate and frame defining a unipolar flow field structure;
a plurality of manifolds formed in the molded frame; and
a molded gasket arrangement disposed proximate a periphery of the manifolds.

2. The structure of claim 1, wherein the gasket arrangement comprises at least one molded gasket disposed proximate a periphery of each of the manifolds.

3. The structure of claim 1, wherein the gasket arrangement comprises a microstructured contact pattern.

4. The structure of claim 1, wherein the gasket arrangement comprises a contact face, and at least a portion of the contact face bears a raised-ridge microstructured contact pattern.

5. The structure of claim 1, wherein the first and second polymers are dissimilar.

6. The structure of claim 1, wherein the first polymer comprises a thermosetting polymeric material, and the second polymer comprises a thermoplastic material.

7. The structure of claim 1, wherein the first and second polymers are similar.

8. The structure of claim 1, wherein the first and second polymers each comprise a thermosetting polymeric material.

9. The structure of claim 1, wherein the gasket arrangement is formed of the non-conductive material comprising the second polymer.

10. The structure of claim 1, wherein the gasket arrangement is formed of a non-conductive material comprising a third polymer, the third polymer dissimilar from the second polymer.

11. The structure of claim 1, wherein the gasket arrangement is formed of a non-conductive material comprising a third polymer, the third polymer having a hardness less than that of the second polymer.

12. The structure of claim 1, wherein a joint is defined between the flow field plate and the frame, the joint defining a seal and an interlocking arrangement between the flow field plate and the frame.

13. The structure of claim 12, wherein the interlocking arrangement comprises a dovetail joint or a partial dovetail joint formed between the flow field plate and the frame.

14. The structure of claim 12, wherein the joint is formed by controlled shrinkage of one or both of the first and second polymers.

15. The structure of claim 1, further comprising a plurality of registration features formed in the molded frame, the registration features configured to provide one or both of intra-cell and inter-cell registration.

16. The structure of claim 15, wherein the registration features comprise one or both of registration recesses and registration posts.

17. The structure of claim 15, wherein the registration features comprise one or more registration recesses on a first surface of the frame and one or more registration posts on a second surface of the frame, a shape of an outer surface of the registration posts differing from a shape of an inner surface of the registration recesses.

18. The structure of claim 1, wherein the flow field plate is substantially devoid of mold registration or sealing artifacts.

19. The structure of claim 1, wherein the frame is substantially devoid of mold registration or sealing artifacts.

20. The structure of claim 1, wherein the flow field structure is sufficiently flexible to form a roll-good comprising a plurality of the flow field structures.

21. The structure of claim 1, wherein at least two of the flow field structures are incorporated into a fuel cell stack assembly.

22. The structure of claim 1, wherein at least two of the flow field structures are incorporated into a fuel cell stack assembly, the structure further comprising an automobile, wherein a plurality of the fuel cell stack assemblies are incorporated in a fuel cell power unit configured to supply power to the automobile.

23. The structure of claim 1, wherein at least two of the flow field structures are incorporated into a fuel cell stack assembly, the structure further comprising a computer, wherein one or more of the fuel cell stack assemblies are incorporated in a fuel cell power unit configured to supply power to the computer.

24. The structure of claim 1, wherein at least two of the flow field structures are incorporated into a fuel cell stack assembly, and one or more of the fuel cell stack assemblies are incorporated in a fuel cell power supply configured to supply power to a load.

25. The structure of claim 1, wherein at least two of the flow field structures are incorporated into a fuel cell stack assembly, the structure further comprising an auxiliary power system, wherein one or more of the fuel cell stack assemblies are incorporated in a fuel cell power unit configured to supply power to the auxiliary power system.

26. A flow field structure for use in a fuel cell assembly, comprising:
a molded flow field plate formed of a conductive material comprising a first polymer;
a molded frame disposed around the flow field plate and formed of a non-conductive material comprising a second polymer, the molded flow field plate and frame defining a unipolar flow field structure; and
a molded coupling arrangement extending from the frame, the molded coupling arrangement configured to couple the unipolar flow field structure with other unipolar flow field structures to define a continuous web of the unipolar flow field structures.

27. The structure of claim 26, wherein the molded coupling arrangement comprises an overmolded coupling arrangement formed between adjacent ones of the unipolar flow field structures.

28. The structure of claim 26, wherein the molded coupling arrangement comprises one or more tabs extending between and connecting adjacent ones of the unipolar flow field structures.

29. The structure of claim 26, wherein the molded coupling arrangement comprises carrier strips defined along opposing sides of the unipolar flow field structures and tabs extending between the unipolar flow field structures and the carrier strips.

30. The structure of claim 26, wherein the molded coupling arrangement comprises a plug and hole interlocking arrangement disposed at corners of adjacent ones of the unipolar flow field structures.

31. The structure of claim 26, wherein the molded coupling arrangement comprises a living hinge disposed between adjacent ones of the unipolar flow field structures.

32. The structure of claim 26, wherein the web of the unipolar flow field structures is sufficiently flexible to form a roll-good of the unipolar flow field structures.

33. The structure of claim 26, wherein the frame comprises a plurality of molded manifolds and a gasket arrangement disposed proximate a periphery of the plurality of manifolds.

34. The structure of claim 33, wherein the gasket arrangement comprises a microstructured contact pattern.

35. The structure of claim 33, wherein the gasket arrangement is formed of the non-conductive material comprising the second polymer.

36. The structure of claim 33, wherein the gasket arrangement is formed of a non-conductive material comprising a third polymer.

37. The structure of claim 26, wherein a joint is defined between the flow field plate and the frame, the joint defining a seal and an interlocking arrangement between the flow field plate and the frame.

38. The structure of claim 26, further comprising a plurality of registration features formed in the molded frame, the registration features configured to provide one or both of intra-cell and inter-cell registration.

39. The structure of claim 26, wherein the first and second polymers are dissimilar.

40. The structure of claim 26, wherein the first polymer comprises a thermosetting polymeric material, and the second polymer comprises a thermoplastic material.

41. The structure of claim 26, wherein the first and second polymers are similar.

42. The structure of claim 26, wherein the first and second polymers each comprise a thermosetting polymeric material.

43. A method of forming a flow field structure for use in a fuel cell assembly, comprising:
molding a flow field plate and manifolds in the flow field plate using a conductive material comprising a first polymer;
molding a frame around the flow field plate using a non-conductive material comprising a second polymer; and
molding a gasket arrangement proximate a periphery of the manifolds.

44. The method of claim 43, wherein molding the flow field plate and the frame comprises forming a seal and an interlocking arrangement between the flow field plate and the frame.

45. The method of claim 43, wherein molding the gasket comprises molding the gasket to incorporate a raised-ridge microstructured contact pattern.

46. The method of claim 43, further comprising molding a plurality of registration features in the frame, the registration features configured to provide one or both of intra-cell and inter-cell registration.

47. The method of claim 43, wherein molding the flow field plate and molding the frame are performed contemporaneously.

48. The method of claim 43, wherein molding the flow field plate and molding the frame are performed using a single molding machine.

49. The method of claim 43, wherein:
molding the flow field plate and the frame are performed in a single molding machine;
molding the flow field plate is performed during a first molding shot; and
molding the frame is performed during a second molding shot, the molding machine remaining closed during and between the first and second molding shots.

50. The method of claim 43, wherein molding the flow field plate is performed in a first molding machine and molding the frame is performed in a second molding machine.

51. The method of claim 43, wherein molding the gasket is performed contemporaneously with molding of the frame.

52. The method of claim 43, wherein molding the gasket is performed subsequent to molding of the frame.

53. A method of forming a flow field structure for use in a fuel cell assembly, comprising:
molding a flow field plate using a conductive material comprising a first polymer;
molding a frame around the flow field plate using a non-conductive material comprising a second polymer, the molded flow field plate and frame defining a unipolar flow field structure; and
molding a coupling arrangement between the unipolar flow field structure and other ones of the unipolar flow field structure to define a continuous web of the unipolar flow field structures.

54. The method of claim 53, wherein molding the coupling arrangement comprises overmolding one or more portions of the frames of adjacent ones of the unipolar flow field structures.

55. The method of claim 53, wherein molding the coupling arrangement comprises molding one or more tabs between adjacent ones of the unipolar flow field structures.

56. The method of claim 53, wherein molding the coupling arrangement comprises molding carrier strips along opposing sides of the unipolar flow field structures and molding tabs between the unipolar flow field structures and the carrier strips.

57. The method of claim 53, wherein molding the coupling arrangement comprises molding a plug and hole interlocking arrangement at corners of adjacent ones of the unipolar flow field structures.

58. The method of claim 53, wherein molding the coupling arrangement comprises molding a living hinge between adjacent ones of the unipolar flow field structures.
